(19) United States
(12) Patent Application Publication
(10) Pub. No.: US 2019/0308297 A1
(43) Pub. Date: Oct. 10, 2019

(54) MACHINE TOOL AND METHOD FOR DETERMINING AN ACTUAL STATE OF A MACHINE TOOL

(71) Applicant: FRITZ STUDER AG, Steffisburg (CH)

(72) Inventor: Bernhard FRUTIGER, Hilterfingen (CH)

(21) Appl. No.: 16/449,786

(22) Filed: Jun. 24, 2019

Related U.S. Application Data
(63) Continuation of application No. PCT/EP2017/084210, filed on Dec. 21, 2017.

(30) Foreign Application Priority Data
Dec. 28, 2016 (DE) 10 2016 125 803.2

(51) Int. Cl. B24B 49/00; B23Q 17/09; B23Q 17/12

(52) U.S. Cl. CPC B24B 49/003; B23Q 17/12; B23Q 17/0971

(57) ABSTRACT

A machine tool comprises a measuring device, which is arranged on the machine tool, a control device, and a tool unit. The measuring device comprises at least one structure-borne sound sensor. T control device is coupled to the measuring device and to the tool unit. The control device is configured to acquire, by means of the measuring device, structure-borne sound signals caused by the machine tool and to determine a state variable, which describes an actual state of the machine tool, by forming a differential spectrum from a broadband reference spectrum and a broadband actual spectrum.

### CROSS-REFERENCES TO RELATED APPLICATIONS

This application is a continuation of international patent application PCT/EP2017/084210, filed on Dec. 21, 2017 and designating the U.S., which international patent application has been published in German language and claims priority to German patent application 10 2016 125 803.2, filed on Dec. 28, 2016. The entire contents of these priority applications are incorporated herein by reference.

### BACKGROUND

In certain aspects, the present disclosure relates to a machine tool, for instance a grinding machine, comprising: a measuring device, which is arranged on the machine tool, wherein the measuring device comprises at least one structure-borne sound sensor; and a control device, which can be coupled to the measuring device and to a tool unit of the machine tool, wherein the control device is configured to acquire, by means of the at least one measuring device, structure-borne sound signals caused by the machine tool and to determine an actual state of the machine tool. The present disclosure also relates to a corresponding method for determining an actual state of a machine tool.

From US 2012/0010744 A1 there is known a method for vibration suppression for a machine tool, for the purpose of avoiding rattling when machining is being performed on a workpiece by means of a machining tool, comprising the steps: acquiring a vibration occurring when the machining tool or the workpiece starts to rotate; determining whether the vibration acquired since the starting of the rotation has exceeded a threshold value; analyzing the vibration by Fourier series expansion if it is established that the vibration has exceeded the threshold value; adjusting a spindle rotational speed of the machine tool, taking account of the acquired vibration and the number of cutting teeth of the machining tool; defining, as a threshold value, a natural vibration occurring during idling of the spindle; and limiting the analysis by Fourier series expansion to only one vibration frequency range in which the rattling actually occurs.

Accordingly, in the case of US 2012/0010744 A1, there is no broadband monitoring of the machine tool. The main focus is on identifying the rattling, and not on broadband monitoring with conclusions regarding various operating states.

Machine tools, for instance grinding machines, or cylindrical grinding machines, are known in the prior art. By way of example, cylindrical grinding machines may comprise rotationally symmetrical tools, for instance grinding wheels. The latter may act together with a workpiece in a suitable manner for the purpose of removing material. Cylindrical grinding machines may be designed, for example, for external cylindrical grinding, internal cylindrical grinding, and also for plunge-grinding or angular-infeed grinding. In principle, besides grinding wheels, abrasive bands may also be used in cylindrical grinding. Besides rotationally symmetrical workpiece surfaces, for instance eccentrically formed workpiece surfaces may also be machined if the workpiece mount and a tool unit, for instance the spindle head, can be driven in an appropriate manner and can be moved relative to each other. In this way, for instance camshafts, crankshafts or similar workpieces having eccentric geometries can be machined, or ground. There are also known machine tools that allow combined machining of workpieces, for instance combined grinding and lathe machines.

A workpiece to be machined may be mounted, for instance, between two centers of a workpiece mount, or alternatively be mounted on one side in a workpiece mount. There is also generally known so-called centerless grinding, in which the workpiece is not mounted (axially) between centers in the grinding machine. Instead, the workpiece may be mounted and guided, for instance, by means of support rails, regulating wheels, guide rollers, rests, or the like.

Machine tools, for instance grinding machines, may have various degrees of automation. There are known, for example, conventional grinding machines in which a tool change, workpiece change and control of the machining operation are performed substantially manually by an operator/worker. Additionally, grinding machines are generally known that can be loaded with workpieces in an automated manner. Machined (for instance ground) workpieces can be unloaded in the same manner. With appropriate handling devices, therefore, substantially autonomous operation can be achieved without the need for manual operator interventions. Such machine tools or production systems are suitable, for instance, for large-scale production. The machine tools are generally configured as single-purpose machines, and are for instance optimized to maximize a ratio of machining times (periods of actual machining) and non-machining times (for instance periods for changing the workpieces).

Machine tools, for instance grinding machines, may have various operating modes. For example, in an automated (productive) operating mode, a previously programmed machining task may be processed substantially fully automatically. Normally, in the case of such operating modes, there is no need for any manual intervention by an operator. Previously stored machining paths enable infeed motions, advance motions and further necessary operations of positioning the tool to be performed autonomously by the machine tool.

Also known, however, are operating modes in which there is a need for an at least partly manual control of components of the machine tool, for instance of the spindle head with the mounted tool. These include, for instance, mounting operations and set-up operations. It is likewise conceivable to have the spindle head of the machine tool controlled by an operator (or set-up operative) when manual measuring operations are being performed. Setting-up may be necessary, for instance, when the tool (for example the grinding wheel) is changed, or at least dressed. For this purpose, for instance, a transfer to defined reference points of the machine tool that are preset on the machine table or machine bed may be necessary. For this, it is often possible firstly to bring the spindle head close to the reference point by means of a coarse motion (rapid traverse), and then to contact the reference point by means of a fine motion (creep traverse) in order to conclude the approach.

It is also generally known to arrange acceleration sensors or structure-borne sound sensors on such machine tools and, by means of such acceleration sensors or structure-borne sound sensors, to draw inferences concerning an actual state of the machine tool. Possible actual states in this case are: operation of the machine tool without machining, for instance grinding, of a workpiece, with the tool, for instance the grinding wheel, already rotating but removal of material not occurring; grinding of the grinding wheel on the workpiece, with removal of material occurring; various intermediate states, i.e. grinding of the grinding wheel on the workpiece substantially without removal of material, or the grinding wheel being contacted by lubricant or coolant, with the grinding wheel not grinding on the workpiece, for example.

Structure-borne sound is to be understood herein to mean, at least in certain embodiments, vibrations of the machine tool that are produced during operation of the machine tool. This also includes acceleration values of the machine tool. It is understood that also sound in the original sense, thus vibrations transmitted through the atmosphere, may be covered by the term structure-borne sound.

It is known to evaluate structure-borne sound signals of the machine tool in a predefined frequency band. In this case, during setting-up of the machine tool, a machine set-up operative selects a frequency band without disturbing secondary noise and with characteristic operating frequencies of the machine tool, with the evaluation of the structure-borne sound signals then to be effected in this band.

It is further known to evaluate the corresponding structure-borne sound signals in a frequency representation, in which case exceeding of a predefined threshold value may indicate a malfunction, for example an excessively rapid infeed or the use of a defective or a wrong tool.

Frequency representation is to be understood herein to mean that the power and/or the amplitude of the structure-borne sound signals is determined in dependence on the frequency.

The setting-up of such a monitoring of a machine tool, for instance a grinding machine, therefore requires trained and experienced specialist personnel, for instance for the selection of a suitable frequency band.

In view of this, it is an object of the present disclosure to present an improved machine tool that addresses at least some of the aforementioned challenges and drawbacks.

It is a further object of the present disclosure to present a machine tool having a monitoring arrangement that is configured for efficient and comprehensive vibration monitoring.

It is a further object of the present disclosure to present a machine tool having a monitoring arrangement that enables instant or nearly instant reaction to potentially defective events.

It is a further object of the present disclosure to present a machine tool having a monitoring arrangement that is easy to operate and to set up.

It is a further object of the present disclosure to present a respectively configured grinding machine, for instance a cylindrical grinding machine.

It is a further object of the present disclosure to present a corresponding method for determining an actual state of a machine tool, for instance a grinding machine.

### SUMMARY

In regard of the machine tool, these and other objects are achieved by a machine tool comprising:
a tool unit,
a measuring device arranged on the machine tool, and
a control device that is coupled to the measuring device and to the tool unit,
wherein the measuring device comprises at least one structure-borne sound sensor,
wherein the control device is configured to
   acquire, by means of the measuring device, structure-borne sound signals caused by the machine tool, involving an acquisition of a broadband reference spectrum and a broadband actual spectrum, and
   determine a state variable by forming a differential spectrum from the broadband reference spectrum and the broadband actual spectrum,
   wherein the state variable describes an actual state of the machine tool on the basis of structure-borne sound signals.

In regard of the machine tool, these and other objects are achieved by a machine tool comprising:
a tool unit,
a measuring device arranged on the machine tool, and
a control device that is coupled to the measuring device and to the tool unit,
wherein the measuring device comprises at least one structure-borne sound sensor,
wherein the control device is configured to
   acquire, by means of the measuring device, structure-borne sound signals caused by the machine tool, and
   determine a state variable by forming a differential spectrum from a broadband reference spectrum and a broadband actual spectrum,
   wherein the state variable describes an actual state of the machine tool on the basis of structure-borne sound signals.

In a further aspect of the present disclosure there is presented a machine tool, for instance a grinding machine, comprising a measuring device, which is arranged on the machine tool, wherein the measuring device comprises at least one structure-borne sound sensor, and comprising a control device, which can be coupled to the measuring device and to a tool unit, wherein the control device is configured to acquire, by means of the at least one structure-borne sound measuring device, structure-borne sound signals caused by the machine tool and to determine an actual state of the machine tool by forming a differential spectrum from a broadband reference spectrum and a broadband actual spectrum.

In regard of the method, these and other objects are achieved by a method for determining an actual state of a machine tool, comprising the following steps:
providing a machine tool comprising a tool unit, a measuring device arranged on the machine tool, and a control device that is coupled to the measuring device and to the tool unit,
wherein the measuring device comprises at least one structure-borne sound sensor,
determining an actual state of the machine tool on the basis of structure-borne sound signals, comprising:
   acquiring structure-borne sound signals of the machine tool, and
   determining a state variable by forming a differential spectrum from a broadband reference spectrum and a broadband actual spectrum,
   wherein the state variable describes an actual state of the machine tool, and
   wherein the actual state of the machine tool is determined on the basis of the differential spectrum.

In a further aspect of the present disclosure there is presented a method for determining an actual state of a machine tool, for instance a grinding machine, wherein the method comprises the following steps: providing a measuring device, wherein the measuring device comprises at least one structure-borne sound measuring device, for instance a piezoelectric sound sensor; acquiring structure-borne sound signals of the machine tool; and determining an actual state by means of the structure-borne sound signals, wherein a differential spectrum is formed from a broadband reference spectrum and a broadband actual spectrum, and wherein the actual state of the machine tool is determined on the basis of the differential spectrum.

According to the present disclosure, due to the use of broadband spectra, setting-up by trained specialist personnel can possibly be avoided. At least, the efforts for this can be reduced. In other words, the machine tool, for instance the grinding machine, can be set up already when it is first powered-up/switched on, such that the machine tool can autonomously determine the actual state in a reliable manner.

By way of example, due to the use of broadband spectra, the desired signal can be greater in relation to the background noise, rendering possible a more accurate and rapid detection of the various actual states.

This approach renders possible more rapid signal processing, wherein it is possible to evaluate the entire frequency range that can be acquired.

In certain embodiments, in accordance with the present disclosure, the measuring device comprises piezoelectric acceleration sensors or piezoelectric sound sensors. It is understood that other suitable sensor types may also be used. It is also conceivable for differing sensor types to be combined with each other.

It is also conceivable to use acoustic transducers in the form of microphones. Such sensors do not necessarily require a fixed connection to those parts of the machine tool at which vibrations occur. The use of microphones as a structure-borne sound sensor can have an impact in respect of cost and function. For example, it is possible for the structure-borne sound sensors to be arranged somewhat away from the immediate machining zone. This greatly reduces the load on the structure-borne sound sensors (mechanical load, load due to cooling lubricant, load due to temperature fluctuations, chips, abrasion, etc.).

It is conceivable to arrange a plurality of microphones in a distributed manner at the machine tool, in order to enable positions or regions to be determined in relation to sound sources, or vibration sources, by means of a direction characteristic. Something of the kind can also be achieved with only one microphone.

Broadband, in respect of the spectra, is to be understood herein to mean that, at least in certain embodiments, the entire frequency range that can be sensed can be used, or detected, for instance without limitation to certain frequency bands. This allows signal processing and evaluation without (narrow-band) frequency bands, which have to be selected manually or by other computational means beforehand.

This may comprise exemplary embodiments in which a particular (broad) portion of the frequency band of the structure-borne sound sensor or structure-borne sound sensors that can theoretically be sensed is used as a basis for the further signal processing, and for instance for the transformation of the sensed signals into the frequency domain. For example, this may comprise exemplary embodiments in which broad bands are used that comprise at least 50%, in certain embodiments at least 75%, in further embodiments at least 90% of the frequencies that can be sensed by the sensor (percentage specifications in relation to axis ranges—in absolute or relative length units—in the case of a logarithmic representation of the frequency band, or frequency response, of the structure-borne sound sensor).

For example, the broad band on which the further processing is based may comprise a range of from one-digit or two-digit Hz (hertz) up to two-digit kHz (kilohertz). In general, the infrasonic, sonic and ultrasonic ranges may be covered, at least partly. However, this is not to be understood to be limiting.

Ideally, there is no need to make any pre-selection whatsoever regarding the frequency band to be processed. Accordingly, the signals sensed by the structure-borne sound sensor can be processed in their entirety and irrespective of their frequency.

In an exemplary embodiment, the control device is configured to evaluate the power of the differential spectrum in its time behavior, i.e. for each actual spectrum, to form the difference from an actual spectrum and the reference spectrum, and to determine the power contained in the differential spectrum, such that a time behavior of the power of the difference spectrum, i.e. of the additional structure-borne sound, is obtained. As used herein, the power of a spectrum may be referred to as spectral power.

In some embodiments, this time behavior is similar to a pulsation, an amplitude thereof being assigned to a time-point. Known evaluation criteria and methods may be used to determine the pulsation parameters. The evaluation of the actual state is simplified, such that the evaluation of the time-dependent amplitude, or pulsation height, may suffice in order reliably to determine the actual state of the machine tool.

In a further exemplary embodiment, the control device is configured to determine the broadband reference spectrum and/or the broadband actual spectrum by a transformation of the structure-borne sound signals into the frequency domain, for instance by a Fourier transform, for instance by a fast Fourier transformation.

The structure-borne sound signals can be acquired and evaluated in their entire bandwidth, wherein a high signal-to-noise ratio of the summed up power of the differential spectrum is obtained, for instance.

The entire bandwidth of the available signal, and not only narrow frequency bands, can be used for evaluation. As a result, the desired signal can be increased significantly in relation to the noise, whereby a more precise and improved evaluation can be achieved.

It is understood that other known transformations into the frequency domain may be used without departing from the scope of the present disclosure, such as, for example, a Gabor transform, wavelet transforms, a Gabor-Wigner transform or a Laplace transform.

The fast Fourier transform (FFT) is an algorithm, known per se, for efficiently calculating a discrete Fourier transform, i.e. a series of measurements having discrete values. It can be used to break down a signal into its frequency components.

The FFT belongs to the so-called divide-and-rule methods, wherein previously calculated intermediate results are reused, and arithmetic computation operations can thereby be simplified.

In a further exemplary embodiment, the control device is configured to record, as a reference spectrum, a transformation of the structure-borne sound signals, in a state in which the machine tool is in operation, but the workpiece is not yet being machined, and to store this in a storage unit. The differential spectrum can thereby be determined in a simple and rapid manner. Moreover, the machine tool itself may define the reference spectrum. By way of example, this enables the machine tool to be set up, or adjusted, in an automated manner. Adjustment by trained and experienced specialist personnel is thus no longer necessary.

Furthermore, upon the renewed recording of a reference spectrum, the new reference spectrum can be compared with the reference spectrum stored in the storage unit. It is thereby possible to discover changes on the machine tool, such as wear or bearing damage.

In a further exemplary embodiment, the control device is configured to determine a new reference spectrum before each machining of a workpiece. The machine tool can thereby react in an extremely sensitive manner to short-term changes, for example to an increased background noise, for example due to an adjacent machine having been put into operation. By way of example, as a result, the machine tool can readjust itself upon each workpiece change, but also upon each tool change. Consequently, in certain embodiments, the downtimes can be kept relatively short, since there is no manual adjustment. Consequently, a comparatively high parts throughput can be achieved, for instance irrespective of the frequency of a tool change.

According to a further exemplary embodiment, the machine tool comprises an output unit, for example a monitor screen, a status indicator, e.g. in the manner of a set of traffic lights, a loudspeaker or a printer, which is configured to receive from the control device and to output a value derived from the time behavior of the power of the differential spectrum. Simple in-process monitoring by a worker/operator is thereby possible, even when the worker is considerably unskilled. Operation of the machine tool outside of the admissible range can easily be identified and also recorded, if necessary.

A status indicator in the manner of a set of traffic lights in this case is, in certain embodiments, an illumination device comprising lamps of differing colors, for example red, green and yellow. The actual state of the machine tool can be indicated by the lamps according to the level of the additional structure-borne sound signals of the actual spectrum in relation to the reference spectrum. For example, threshold values can be defined for the time behavior of the power of the differential spectrum, i.e. for the amplitude of the pulsation described above, such that, below a first threshold value, a green light is illuminated, between a first and a second threshold value a yellow light is illuminated, and above the second threshold value a red light is illuminated. Red illumination of the light may indicate that the additional structure-borne sound is greater than provided for, which may mean that the machine tool is being operated outside of the admissible range.

Additional structure-borne sound signals are to be understood herein to mean the excess power contained in the differential spectrum. In this case, for example, this involves the structure-borne sound produced as a result of the machining by the machine tool.

According to a further exemplary embodiment, the control device is configured to control the tool unit on the basis of the structure-borne sound signals, for instance the infeed speed and further process parameters of the tool unit, for instance the rotational speed. It is thereby possible to implement automatic switch-off of the machine tool, in order to counteract damage to the machine tool, and/or to the workpiece, and/or possible hazards to an operator/worker, in an efficient and rapid manner.

Furthermore, it is thereby possible to realize a self-learning machine tool, the control device of the machine tool itself regulating the infeed speed and further process parameters on the basis of the structure-borne sound signals. In this way, an optimized process sequence can be achieved, for instance in respect of the machining speed.

In certain embodiments, a reaction to different workpiece qualities and tool qualities is possible during the machining operation, such that corresponding tolerances can be expanded if necessary.

It is to be understood that the previously mentioned features and the features mentioned in the following may not only be used in a certain combination, but also in other combinations or as isolated features without leaving the spirit and scope of the present disclosure.

### BRIEF DESCRIPTION OF THE DRAWINGS

Further features and advantages of the disclosure are disclosed by the following description of a plurality of exemplary embodiments, with reference to the drawings, wherein:

FIG. 1 shows a perspective view of a machine tool that is arranged as a grinding machine and comprises an enclosure;

FIG. 2a shows a perspective top view of a machine tool;

FIG. 2b shows a schematic block diagram of components of the measuring device;

FIG. 3a shows an example of a broadband reference spectrum;

FIG. 3b shows an example of a broadband actual spectrum;

FIG. 3c shows an example of a broadband differential spectrum, formed from a difference of an actual spectrum and a reference spectrum;

FIG. 4 shows a schematic representation of a power peak, for example in a differential spectrum or a reference spectrum;

FIG. 5 shows, schematically and exemplarily, the time behavior of the power values in the differential spectrum; and

FIG. 6 shows a schematic, simplified flow diagram of an exemplary method for determining an actual state of a machine tool.

### DETAILED DESCRIPTION OF EXEMPLARY EMBODIMENTS

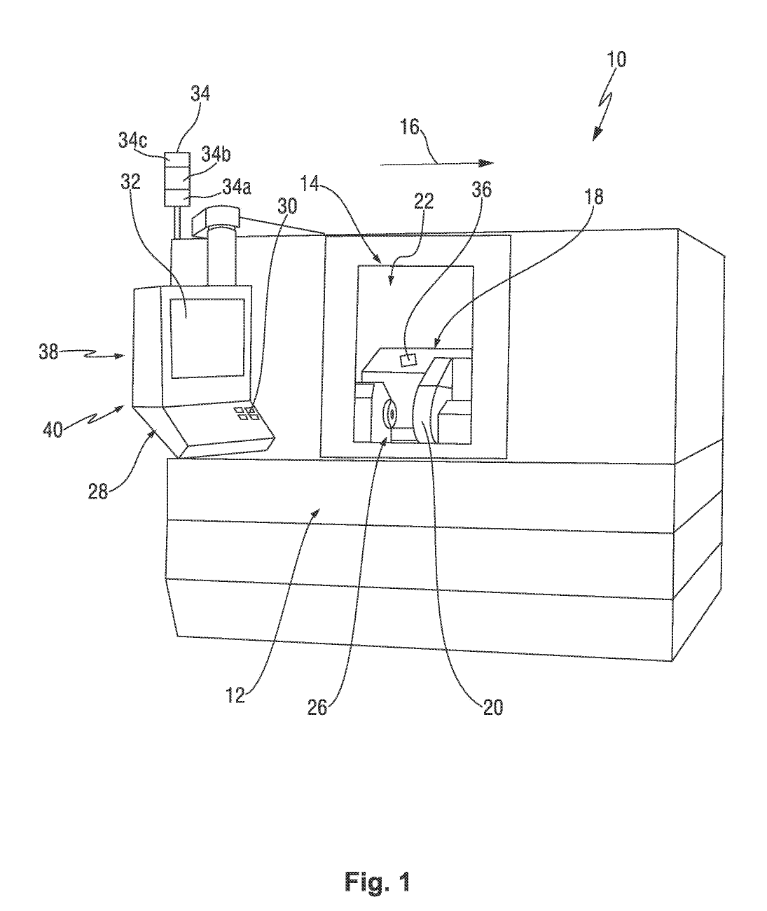

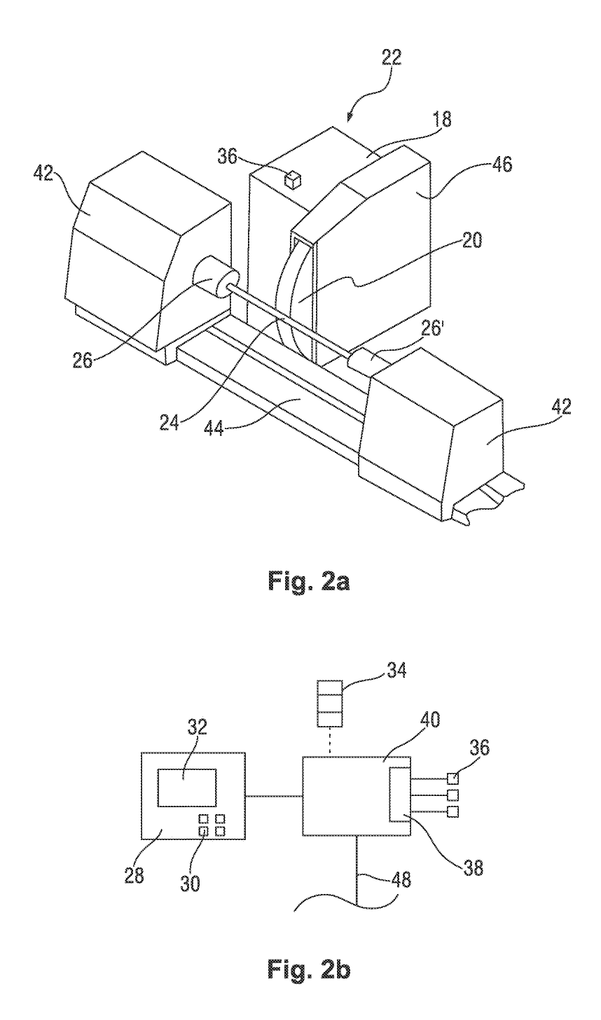

In FIG. 1, a machine tool is represented in perspective view and denoted as a whole by 10. FIG. 2 shows a corresponding top view, for instance of the machine tool 10 according to FIG. 1, wherein various components are not represented for reasons of clarity.

The machine tool 10 in the present case is arranged as a grinding machine, for instance as a cylindrical grinding machine, in general also as a horizontal grinding machine. The machine tool 10 comprises an enclosure 12, which acts as a housing. The enclosure 12 may also be provided with a viewing window 14. The enclosure 12 in this case defines a process space, which is closed, or closable, to the outside, at least in certain embodiments. The enclosure 12 provides for a safe delimitation of the process space of the machine tool 10, for instance in the case of automated machining operations. In this way, in principle, the hazard presented by moving components can be minimized. Moreover, lubricant, coolant, chips or, for example, sparks can be prevented from unwantedly escaping into the surroundings. To render the process space of the machine tool 10 accessible, the enclosure 12 may be appropriately provided with doors or flaps.

In the case of particular operating modes, it may be necessary for the viewing window 14 to be arranged as a type of protective door, in order that the interior of the machine tool can be reached from the outside by an operator. For this purpose, the viewing window 14 may be moved, or swiveled, laterally, for example, in order to release a previously closed opening. An arrow denoted by 16 indicates a possible opening movement of the protective door.

Operating modes that necessitate access into the interior of the machine tool 10 may be, for example, tool-setting operations, setting-up operations, truing operations, or generally tool-change or workpiece-change operations. It is understood that, depending on the degree of automation of the machine tool 10, differing operating modes may necessitate manual access into the interior of the machine tool 10.

Also indicated in FIG. 1, in the interior of the machine tool 10, is a tool unit 22 that comprises a spindle head 18. There is a tool 20 mounted on the spindle head 18. This tool 20 may be, for instance, a grinding tool, for instance a grinding wheel.

The machine tool 10 further comprises a workpiece mount 26, which is configured to support a workpiece 24. For reasons of clarity, FIG. 1 does not show a workpiece 24. For the purpose of machining a workpiece, the spindle head 18 can be moved axially relative to the tool receiver 26.

Machine tools 10, for instance grinding machines, usually have a worker interface or operator interface 28, arranged outside of the interior of the machine tool 10. Consequently, an operator can control, program or adjust the machine tool 10 or, for example, perform diagnostics without coming into contact with the interior of the machine tool 10. The operator interface 28 is, in certain embodiments, an operating unit, which comprises at least one input device 30 for inputting control commands. The operator interface 28 may further comprise an output unit 32, for example a monitor screen. Moreover, it is conceivable to use a so-called touchscreen, i.e. a combined input and output unit.

In addition, a status indicator 34 may be provided, which for example comprises a red lamp 34a, an orange or yellow lamp 34b and a green lamp 34c, in order to represent the actual state of the machine. In other words, the status indicator 34 may be of a design somewhat similar to that of a set of traffic lights. Other designs of the status indicator 34 are readily conceivable.

Also schematically represented in FIG. 1 is a sensor 36, for instance a piezoelectric acceleration or structure-borne sound sensor. This sensor 36 is, in certain embodiments, arranged close to the tool 20 and connected, wirelessly or by cable, to a measuring device 38 that is not represented. The measuring device 38 may be integrated in a control device 40, in certain embodiments, and the control device 40 may be integrated into the operator interface 28, in certain embodiments.

Alternatively or additionally, sensors 36 may be provided, which are configured as microphones or acoustic transducers and which cover a broadband frequency spectrum, for instance in the audible sound range (20 Hz to 20 kHz) or even above, also in the infrasonic and/or ultrasonic range. Sensors 36 configured in such a manner may also be arranged at a distance from the tool 20 or other moving components of the machine tool 10.

Clearly, it is also conceivable to arrange a plurality of these sensors 36 on the machine tool 10, for instance close to the workpiece 24 to be machined.

FIG. 2a shows a simplified, perspective top view of a machine tool 10, which in principle may correspond to, or at least be similar to, the machine tool 10 according to FIG. 1. For reasons of clarity, the design represented in FIG. 2a does not have an enclosure 12 or an operator interface 28 or set of traffic-signal type lights 34.

FIG. 2a shows the workpiece mount 26 in simplified form. It is arranged on a workpiece carrier 42, which can be moved axially along a guide 44. It is further conceivable to provide a further workpiece carrier, or tailstock 42′, having a further workpiece holder 26′, at an axial end of the guide 44 that is opposite the workpiece carrier 42, in order thus to fix the workpiece 24 in position between the workpiece holders 26 and 26′, for the purpose of machining the tool 20.

In the present case the tool 20 comprises a tool casing 46, this tool casing 46 being arranged on the spindle head 18 and at least partly surrounding the tool 20. An acceleration or structure-borne sound sensor 36 is represented schematically on the spindle head 18. A corresponding structure-borne sound sensor 36 may also be arranged, for instance additionally, on the workpiece carrier 42 or on the workpiece carrier 42′.

Represented schematically in FIG. 2b are electrical connections and/or wireless connections of the measuring device 38 to one or more structure-borne sound sensors 36. Also shown are connections of the control device 40 to the operator interface 28, which is not represented in FIG. 2a, and a connection, indicated exemplarily by a broken line, to the status indicator in the form of a set of traffic lights 34.

Further shown in FIG. 2b is a connection 48 to the (higher-order) control system of the machine tool 10.

For the purpose of machining a workpiece 24, the workpiece is first inserted in the workpiece holder 26 and fixed in position, for instance clamped, such that the workpiece 24 is held by the workpiece holder 26. The tool 20 and the spindle head 18 are configured to be movable, such that the tool 20 can be moved to the workpiece 24 in order to machine it. It is conceivable in this case that the tool 20, for instance the entire spindle head 18, is configured to be movable by more than one spatial direction, in order to ensure comprehensive machining of the workpiece 24, at least in some embodiments.

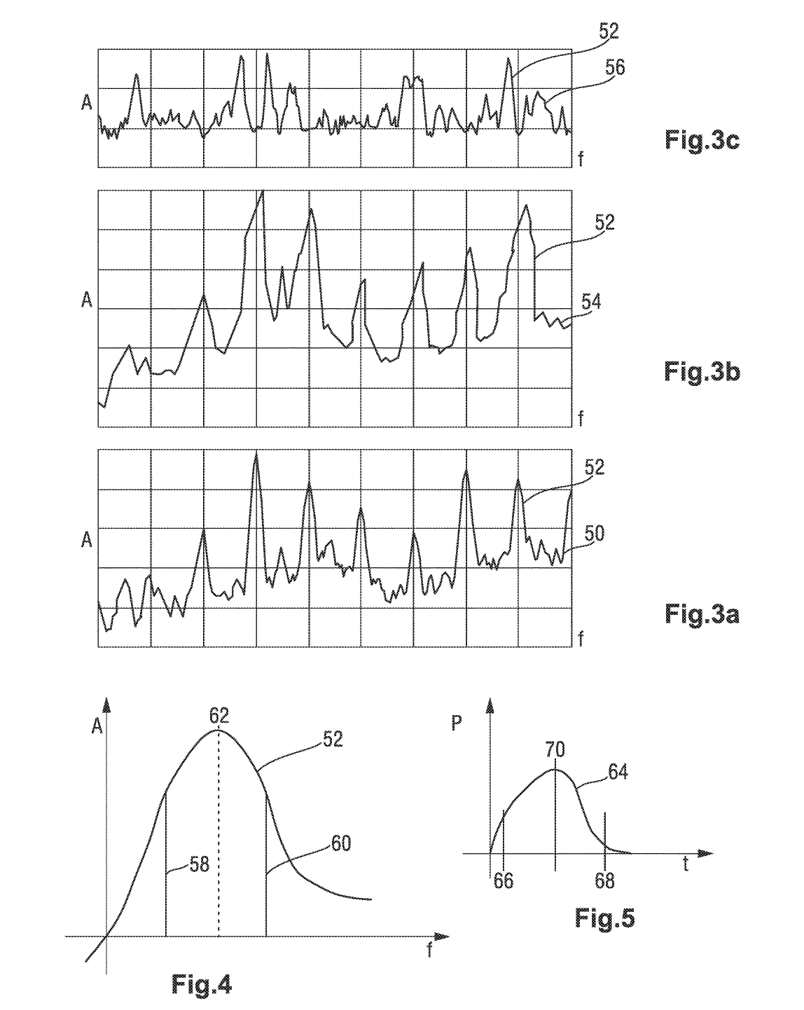

In a state in which the tool 20 is already rotating, but the workpiece 24 is not yet being machined, the control device 40 can initiate recording of a reference spectrum 50 (or background spectrum). In this case, the control device 40 reads-out directly, or indirectly, i.e. via the measuring device 38, the signals of the at least one structure-borne sound sensor 36, and transforms the signals, recorded in time series, into a frequency representation. There are a multiplicity of algorithms available for this purpose, the fast Fourier transform algorithm (FFT) being used in the present case, at least in certain embodiments, and not to be understood in a limiting sense. Such a reference spectrum 50 is represented schematically in FIG. 3a.

Understood herein as a time series is the vibration amplitude of the machine tool 10, i.e. the structure-borne sound.

A representation in which the amplitudes of the vibrations of the machine tool 10, i.e. the structure-borne sound, are sensed/calculated/represented in respect of their frequency components is understood as a frequency domain. The frequency domain provides information on the amplitude and frequency at which the machine tool 10 is vibrating.

When the workpiece 24 is being machined, for instance ground or polished, by the tool 20, the signals that can be sensed by the structure-borne sound sensors 36, i.e. the structure-borne sound of the machine tool 10, change. The control device 40 in this case can record a so-called actual spectrum 54, i.e. can read-out the signals of the structure-borne sound sensors 36 and transform them into the frequency domain. The reference spectrum 50 can then be subtracted from the thus obtained actual spectrum 54, in order to obtain a differential spectrum 56. A corresponding actual spectrum 54 is shown exemplarily in FIG. 3b. A corresponding differential spectrum 56 is shown exemplarily in FIG. 3c.

Usually, such spectra have differing so-called peaks 52. These peaks 52 show how much power of the structure-borne sound is present in a certain frequency (band). The peaks 52 are produced primarily as the result of the occurrence of a periodic motion such as, for example, the rotation of the tool 20. The peaks 52 show dominant or characteristic, structure-borne sound frequencies that can occur during operation of the machine tool 10. Usually, these peaks 52 are not “sharp”, but have a certain lack of definition, i.e. width, in the frequency domain. This is associated, for instance, with the fact that the structure-borne sound signals are partially damped, and for instance a certain dispersion of the structure-borne sound signals in the machine tool 10 occurs as the structure-borne sound propagates from the source of the structure-borne sound to a structure-borne sound sensor 36.

It is understood that the reference spectrum 50 may be stored in a storage unit of the control device 40 in order to enable a rapid calculation of the differential spectrum 56.

In certain embodiments, during operation of the machine tool 10, actual spectra 54 are determined continuously and subtracted from the reference spectrum 50, in order to obtain corresponding differential spectra 56.

The power contained in the differential spectra 56, i.e. the area under the curve of a differential spectrum 56, is added up.

In this case, the power contained in a peak 52, as represented schematically in FIG. 4 by an ideal-characteristic peak 52, can be determined as follows: The area content of an area that is defined by the lines 58 and 60 and the peak 52 can be calculated in a manner known per se. In this case the lines 58 and 60 are arranged symmetrically around a peak maximum 62. All areas obtained in such a manner are then added up.

It is understood that this method is cited only by way of example. It is also conceivable to add up each individual discrete value of the differential spectrum 56, in the manner of a numerical integration. A value of the differential spectrum is multiplied by the corresponding interval width, also in this case referred to as the resolution of the spectrum, in order to determine a sub-area below the spectrum. The thus obtained subareas are then added in order to determine the area contained in the spectrum, and thus the power.

Then, as represented schematically in FIG. 5, the power contained in the differential spectra 56 can be plotted over time. In FIG. 5, power contained in the differential spectrum 56 is plotted along the ordinate, with time being plotted along the abscissa. In this way, a type of pulsation 64 can be determined, this pulsation 64 providing information on the magnitude of the power of the broadband structure-borne sound signal in relation to the background noise, i.e. the reference spectrum 50.

This means, in other words, the lesser the amplitude of the pulsation 64, the less additional structure-borne sound of the machine tool 10 has been acquired. In a state in which a workpiece 24 is not yet being machined by the machine tool 10, there is no additional structure-borne sound present, at least in certain embodiments. This means that the pulsation 64 has a relatively low amplitude, for instance close to 0. Such as state is shown, for example, by the references 66 and 68 in the case of the pulsation 64 in FIG. 5.

As the intensity of machining of a workpiece 24 increases, the additional structure-borne sound also increases. As a result, the power contained in the differential spectra 56 increases, and ultimately the amplitude of the pulsation 64. Such a state is shown, for instance, by the reference 70 in the case of the pulsation 64 in FIG. 5.

By evaluation of this pulsation 64, the actual state of the machine tool 10 can be determined in a simple manner. In this case, for example, threshold values may be defined for the obtained pulsation 64 and, if a corresponding threshold value is exceeded, for example an alarm signal may be output to an operator.

It is further possible to switch off the machine tool 10 in an automated manner upon exceeding of a threshold value, in order thus to prevent damage to the workpiece 24 or to the machine tool 10, or even to prevent any hazard to an operator.

Moreover, it is possible to regulate the infeed or machining speed of the machine tool 10, such that the machining of a workpiece 24 is controlled according to the contained power in the differential spectrum 56, i.e. according to the additional structure-borne sound, and ultimately in dependence on the pulsation 64.

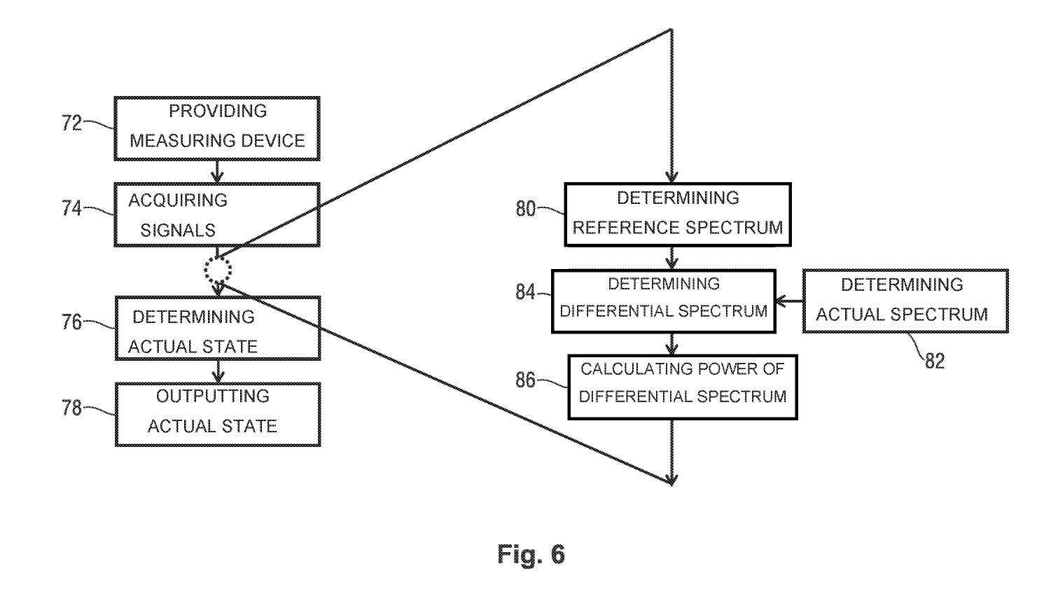

Illustrated in a highly simplified manner in FIG. 6, on the basis of a schematic flow diagram, is an exemplary method for determining an actual state of a machine tool 10. In this case, in a first step 72, a measuring device 38 is provided, which comprises at least one structure-borne sound sensor 36, for instance a piezoelectric sound sensor 36. In a following step 74, the structure-borne sound signals of the machine tool 10 are acquired, the actual state of the machine tool 10 being determined, in a following step 76, by means of the acquired structure-borne sound signals. The differential spectrum 56 is formed from a broadband reference spectrum 50 and a broadband actual spectrum 54, wherein the actual state of the machine tool 10 is determined on the basis of the differential spectrum 56. The actual state of the machine tool 10 can then be output, in a following step 78.

In certain embodiments, the power of a differential spectrum 56 is evaluated between the acquisition of the structure-borne sound signals of the machine tool 10 in step 74 and the determining of the actual state of the machine tool 10 in step 76. This is to be explained in greater detail in the following.

In a step 80, a reference spectrum 50 is compiled on the basis of the acquired structure-borne sound signals, wherein in this case the structure-borne sound signals are sensed while the machine tool 10 is in operation, but the workpiece 24 is not yet being machined, at least in certain embodiments. In a further step 82, an actual spectrum 54 is determined on the basis of acquired structure-borne sound signals, the structure-borne sound signals being recorded while the machine tool 10 machines the workpiece 24. In the determination of the spectra, i.e. the actual spectrum 54 and the reference spectrum 50, the structure-borne sound signals are transformed into the frequency domain, for instance by means of FFT.

In a subsequent step 84, the reference spectrum 50 is subtracted from the actual spectrum 54, and as a result a differential spectrum 56 is determined, and the power contained in the differential spectrum 56 is added up. In a following step 86, the power contained in the differential spectrum 56 is represented/evaluated as amplitude over time. Then, in step 76, the actual state of the machine tool 10 can be determined on the basis of this amplitude.

The structure-borne sound/vibration of the machine tool 10 is acquired continuously or quasi-continuously, at least in certain embodiments, wherein the reference spectrum 50 is subtracted from the thereby obtained actual spectra 54, in order to determine, at each time-point, a differential spectrum 56, for instance the power in the differential spectrum 56, and thus the additional structure-borne sound. The thus obtained characteristic of the power in the differential spectra 56 over time is equal to a pulsation 64.

The actual state of the machine tool 10 may be determined at each time-point. In general, it is thus possible to determine the actual state of the machine tool 10 directly, or with only a slight delay, such that malfunctions can be identified at an early stage and damage to the machine tool 10 can reliably be prevented.

Moreover, in this way, predictions become possible. For example, as a result of determination of the instantaneous rise of the pulsation 64, the further characteristic can be estimated. It is thus possible to react accordingly, even before the machine tool 10 is operated outside of the admissible range.

It is further conceivable to create a self-regulating machine tool 10, since controlled variables, such as the rotational speed of the tool 20 or the infeed speed of the workpiece 24, can be regulated on the basis of the actual state such that the structure-borne sound signals obtained, for instance the amplitude of the obtained pulsation 64 remains, as far as possible, within the admissible range. The self-regulating machine tool 10 can thereby be controlled more rapidly and with greater precision than a machine tool 10 that is set-up by an operator.

What is claimed is:

1. A machine tool comprising:
a tool unit,
a measuring device arranged on the machine tool, and
a control device that is coupled to the measuring device and to the tool unit,
wherein the measuring device comprises at least one structure-borne sound sensor,
wherein the control device is configured to
acquire, by means of the measuring device, structure-borne sound signals caused by the machine tool, involving an acquisition of a broadband reference spectrum and a broadband actual spectrum, and
determine a state variable by forming a differential spectrum from the broadband reference spectrum and the broadband actual spectrum,
wherein the state variable describes an actual state of the machine tool on the basis of structure-borne sound signals.

2. The machine tool as claimed in claim 1, wherein the differential spectrum has a power, and wherein the control device is further configured to evaluate a time behavior of the power of the differential spectrum.

3. The machine tool as claimed in claim 1, wherein the control device is configured to determine the broadband reference spectrum and the broadband actual spectrum by a transformation of the structure-borne sound signals into the frequency domain.

4. The machine tool as claimed in claim 3, wherein the control device is configured to determine at least one of the broadband reference spectrum and the broadband actual spectrum by one of a Fourier transformation and a fast Fourier transformation of the structure-borne sound signals into a frequency domain.

5. The machine tool as claimed in claim 3, wherein the control device is configured to determine the broadband reference spectrum and the broadband actual spectrum by a transformation of the structure-borne sound signals into the frequency domain.

6. The machine tool as claimed in claim 1, wherein the control device is configured to record, as the reference spectrum, a transformation of the structure-borne sound signals in a state in which the machine tool is in operation, but a workpiece is not yet being machined.

7. The machine tool as claimed in claim 1, wherein the control device is configured to determine a new reference spectrum before each machining of a workpiece.

8. The machine tool as claimed in claim 2, further comprising an output unit that is supplied with the time behavior of the power of the differential spectrum from the control device, and configured to output the time behavior of the power of the differential spectrum.

9. The machine tool as claimed in claim 1, wherein the machine tool comprises a tool unit having a tool spindle that supports and drives a tool, wherein the control device is configured to control the tool unit on the basis of the structure-borne sound signals, wherein the machine tool is arranged as a grinding machine, and wherein the tool unit comprises at least one grinding wheel.

10. A machine tool comprising:
a tool unit,
a measuring device arranged on the machine tool, and
a control device that is coupled to the measuring device and to the tool unit,
wherein the measuring device comprises at least one structure-borne sound sensor,
wherein the control device is configured to
acquire, by means of the measuring device, structure-borne sound signals caused by the machine tool, and
determine a state variable by forming a differential spectrum from a broadband reference spectrum and a broadband actual spectrum,
wherein the state variable describes an actual state of the machine tool on the basis of structure-borne sound signals.

11. A method for determining an actual state of a machine tool, the method, comprising the following steps:
providing a machine tool comprising a tool unit, a measuring device arranged on the machine tool, and a control device that is coupled to the measuring device and to the tool unit,
wherein the measuring device comprises at least one structure-borne sound sensor,
determining an actual state of the machine tool on the basis of structure-borne sound signals, comprising:
acquiring structure-borne sound signals of the machine tool, and
determining a state variable by forming a differential spectrum from a broadband reference spectrum and a broadband actual spectrum,
wherein the state variable describes an actual state of the machine tool, and
wherein the actual state of the machine tool is determined on the basis of the differential spectrum.

12. The method as claimed in claim 11, wherein the differential spectrum has a power, and wherein a time behavior of the power of the differential spectrum is evaluated in its.

13. The method as claimed in claim 11, wherein at least one of the broadband reference spectrum and the broadband actual spectrum is determined by a transformation of the structure-borne sound signals into a frequency domain.

14. The method as claimed in claim 13, wherein at least one of the broadband reference spectrum and the broadband actual spectrum is determined by one of a Fourier transformation and a fast Fourier transformation of the structure-borne sound signals into the frequency domain.

15. The method as claimed in claim 11, wherein the broadband reference spectrum and the broadband actual spectrum are determined by a transformation of the structure-borne sound signals into the frequency domain.

16. The method as claimed in claim 11, wherein the reference spectrum is determined in a state in which the machine tool is in operation, but a workpiece is not yet being machined.

17. The method as claimed in claim 11, wherein, upon a renewed recording of a reference spectrum, the new reference spectrum is compared with the stored reference spectrum, in order to detect changes in the state of the machine tool.

18. The method as claimed in claim 11, wherein the control device is configured to determine a new reference spectrum before each machining of a workpiece.

19. The method as claimed in claim 11, wherein the time behavior of the power of the differential spectrum is provided at an output unit of the control device.

20. The method as claimed in claim 11, wherein a new reference spectrum is recorded before each machining of a workpiece.
